(19) United States
(12) Patent Application Publication
(10) Pub. No.: US 2023/0141591 A1
(43) Pub. Date: May 11, 2023

(54) RFID ENABLED WAREHOUSE MANAGEMENT SYSTEM AND METHOD

(71) Applicant: Dematic Corp., Grand Rapids, MI (US)

(72) Inventor: Dan Howarth, Wauwatosa, WI (US)

(21) Appl. No.: 17/983,095

(22) Filed: Nov. 8, 2022

Related U.S. Application Data
(60) Provisional application No. 63/276,896, filed on Nov. 8, 2021.

(51) Int. Cl. B65G 1/137

(52) U.S. Cl. CPC B65G 1/1375

(57) ABSTRACT

A system and method are provided for auditing the inventory within an automated warehouse utilizing RFID technology. The system and method enable real-time tracking and monitoring of inventory and load units as they travel through and are stored in the warehouse. The system may require only a single RFID reader coupled with an automated shuttle for traversing a majority of the warehouse storage system to read, recognize, and audit the inventory as stored in load units stored in the system. The system may utilize multiple RFID readers throughout the warehouse to provide ample coverage, enabling real-time, whole warehouse inventory tracking. The system and method of the present invention contemplate both readily available RFID technologies, as well as advanced or improved RFID technologies having greater detection range, larger information storage capabilities, and the ability to determine precise spatial location of tags relative a reader.

### CROSS REFERENCE TO RELATED APPLICATION

The present application claims priority of U.S. provisional application Ser. No. 63/276,896 filed Nov. 08, 2021, which is hereby incorporated by reference herein in its entirety.

### FIELD OF THE INVENTION

The present invention is directed to order-fulfilment and inventory management, and in particular to load unit warehousing operations.

### BACKGROUND OF THE INVENTION

Load units (LUs; e.g. inventory totes, receptacles, shipping cartons, etc.) are commonly tracked within a warehouse or order fulfilment facility by messages sent between a programmable logic controller (PLC) and the warehouse management system (WMS) software. If a mechanical fault or manual intervention moves, dislodges, or removes a load unit from its stored location, the inventory as tracked by the WMS may become inaccurate. Inaccuracies regarding the location of load units within the warehouse may result in machine faults, inaccurate retrieval of load units, and downtime for correction. Because inventory load units are tracked via the PLC and WMS software, any mechanical mishaps within the warehouse may not be recognized and registered with the WMS.

Typically, a load unit is only scanned when it enters a particular function of the warehouse, such as when a load unit enters an automated storage and retrieval system (ASRS), and load handling units (LHUs; e.g. shuttles, autonomous mobile robots (AMRs), conveyors, and the like) then transport the load unit to its assigned location within the ASRS. The load unit is not scanned again or tracked by the PLC or WMS until it leaves the ASRS. Therefore, any malfunctions or miscues that occur while the load unit is within the ASRS may result in faults or mishaps, such as the load unit missing its assigned location. For example, if a load unit is stored at a location other than its assigned location, the WMS may direct a shuttle to the assigned location to retrieve the load unit, but the shuttle may not find the load unit at the assigned location and the shuttle may register an error, move to the next assigned task, or retrieve an incorrect load unit that is nearby where the target load unit should have been. Therefore, the WMS would be unable to locate that load unit unless the ASRS is manually audited. As such, the actual inventory on hand and the positions of particular inventory within the warehouse may be different as compared to the inventory and their positions as stored in the warehouse management system.

Intermittent auditing may be required to attempt to maintain a generally accurate inventory database that accurately matches the physical inventory on-hand and the physical inventory's positions within the warehouse. Auditing may be performed by operators manually entering the ASRS and comparing the physical inventory with what is registered in the warehouse management system. Such auditing processes are labor intensive and result in significant downtime for that portion of the warehouse.

### SUMMARY OF THE INVENTION

The present invention provides a system and method for automatically auditing the inventory within an automated warehouse, such as an automated storage and retrieval system (ASRS). The system and method utilize radio frequency identification (RFID) technologies, including RFID readers and tags, to enable efficient auditing within the warehouse. The automatic warehouse includes a warehouse management system (WMS) having an inventory database detailing what inventory should be present in the warehouse as well as where particular inventory should be stored in the warehouse. The system and method utilize the RFID components to determine actual, physical locations of load units (e.g. totes, receptacles, cartons, etc.) within the warehouse. The warehouse management system (WMS) then compares the determined actual locations of load units with the expected locations in the inventory database and makes appropriate corrections to the database and/or the load units. The system may reduce or eliminate undesirable downtime that typically may be required to audit the inventory stored within a warehouse.

According to one form of the present invention, a method is provided for auditing the inventory of a warehouse by comparing data stored in a WMS with actual physical locations of load units in the storage system to determine if the WMS requires updates or if load units need repositioned in the storage system. The method includes controlling an automated storage system, such as an ASRS, in which inventory items are stored in a plurality of load units stored at storage locations throughout the storage system. One or more RFID readers within the system attempt to read and recognize RFID tags affixed to some or all of the load units that are present in the storage system. RFID readers may be positioned throughout the storage system to form a network and a blanket of coverage for reading RFID tags in the system. Alternatively, a single RFID reader may be coupled to a load handling unit (LHU; e.g. automated shuttle, autonomous mobile robots, and the like) and operable to traverse the storage system and read RFID tags of the load units within the system. Each RFID reader provided is in communication with the WMS. For every load unit RFID tag that is recognized, the respective RFID reader that read the tag transmits the data or information from the tag to the computer of the WMS. The WMS utilizes the data it receives regarding a particular RFID tag and determines a position of that load unit relative to a reference location within the storage system or warehouse, such as relative to the RFID reader that read the tag, for example. The system may include a warehouse positioning system in communication with the WMS, which also receives information from the RFID reader. The positioning system may facilitate determining the location of a particular RFID tag, of RFID readers within the system, the shuttle of the storage system, or other components of the warehouse, as will be appreciated. The method includes comparing the determined location of each load unit (via its RFID tag) with a database or listing of assigned load unit storage locations determined by and/or stored in the WMS. The location assignment database includes an assigned storage location for at least some of the load units within the storage system. The WMS relies on the location assignment database for directing nearly all of the warehouse operations, including directing shuttles to retrieve a particular load unit when its contents are required for order fulfilment or other downstream processes. The WMS then audits the inventory database and location assignment database by determining whether a particular load unit's determined location matches its assigned storage location. If the determined location of a load unit does not match its assigned storage location, the WMS updates that load unit's assigned storage location in the database to correspond to the load unit's actual determined location.

In one aspect, the storage system includes a storage rack defining at least some of the plurality of storage locations and at least one shuttle operable within an aisle of the storage rack. The RFID reader is disposed on the shuttle such that the RFID reader travels throughout the storage rack along with the shuttle. The method includes controlling the shuttle, with the WMS, to traverse along the aisle and monitoring the location of the shuttle with the warehouse positioning system which is adapted to determine a location of the shuttle relative to the storage rack. As the shuttle traverses the aisle, the RFID reader on the shuttle attempting to read and recognize an RFID tag of each load unit that is stored at a storage location adjacent to the aisle. Determining the position of the respective load unit includes correlating the position of the shuttle with each load unit RFID tag that is recognized to determine a location of each respective load unit relative to the storage rack. The RFID reader may be fixed to a portion of the shuttle (e.g. on the shuttle's chassis), moveably coupled to the shuttle (e.g. on an extendable arm of the shuttle), or selectively supported on the shuttle, such as within a load unit supported on the shuttle. For example, the RFID reader may be positioned within a load unit and the shuttle is operable to retrieve the load unit and RFID reader when required for auditing processes. As such, the RFID reader may be stored apart from the shuttle when auditing processes are not required.

In another aspect, the storage rack includes rows extending perpendicular to the aisle and each row has at least one storage location. The shuttle includes an extendable arm selectively operable to extend into a row to attempt to read an RFID tag of a load unit present in that row. The RFID reader is coupled to the extendable distal end of the extendable arm. The task of attempting to read and recognize an RFID tag of each load unit includes the WMS stopping the shuttle along the aisle adjacent a row and then extending the extendable arm toward that row such that the RFID reader is in close proximity to a load unit at a storage location within that row. The RFID reader attempts to read and recognize the RFID tag on the respective load unit. Each row may include a plurality of storage locations for storing load units and the extendable arm is operable to extend beyond the first load unit in a row (i.e. the load unit closest to the aisle) in order to attempt to read an RFID tag of another load unit at a storage location behind the first load unit.

In still another aspect, the storage system includes a storage rack defining at least some of the storage locations of the system and the storage system includes a plurality of the RFID readers positioned in spaced arrangement throughout the storage rack with each RFID reader having a known reference location relative to the storage rack. Each of the RFID readers is in communication with the WMS and operable to read RFID tags of load units which are stored at storage locations which are within sufficiently close proximity to the respective RFID reader. Determining a position of the respective load unit includes the warehouse positioning system receiving information from one of the plurality of RFID readers that has read and recognized the RFID tag of the respective load unit and calculating the location of the respective load unit relative to the storage rack based on information about that RFID tag and the known reference location of that RFID reader.

In yet another aspect, the storage system includes a storage rack having a plurality of levels each level defining a plurality of storage locations. The system includes a shuttle operable to traverse an aisle of at least one of the levels of the storage rack to store and retrieve load units at the plurality of storage locations adjacent the aisle. And the system includes a lift system operable to transport load units between levels of the storage rack. An RFID reader is positioned proximate the lift system for reading RFID tags of load units transported by the lift.

In another form of the present invention, an RFID enabled material handling system is provided for an automated warehouse that includes a warehouse management system with a computer for controlling the material handling system. The system includes an automated storage and retrieval system (ASRS) having a storage rack with a plurality of rack levels defining storage locations that Radio frequency identification (RFID) readers are positioned proximate various portions of the ASRS and each RFID reader has a known location relative to the ASRS which is stored in a database within the WMS. Each RFID reader is in communication with the computer and is configured to read and recognize an RFID tag coupled to a load unit that is present in the ASRS within sufficient proximity to the respective one of the RFID readers. The required proximity within which an RFID tag must pass relative to the RFID reader may be a function of the type of RFID technology utilized with the system (e.g. ultra-high-frequency (UHF) RFID tags, low-frequency (LF) RFID tags, etc.). Each RFID reader communicates information associated with a recognized RFID tag to the computer. The computer is operable to determine a location of a load unit relative to the ASRS (or another reference location within the warehouse) utilizing information of the load unit's RFID tag as provided by the respective RFID reader along with the known location of the respective RFID reader relative to the ASRS.

In one aspect, the ASRS includes a shuttle operable to traverse an aisle of at least one of the plurality of rack levels of the storage rack. An RFID reader is provided with the shuttle and is operable to read and recognize RFID tags of load units that are stored at storage locations adjacent the aisle and/or supported at the shuttle. The RFID reader at the shuttle communicates information associated with a recognized RFID tag to the computer. The RFID reader may either be fixed to a portion of the shuttle, moveably coupled to the shuttle, or selectively supported on the shuttle. For example, the RFID reader may be contained within a load unit such that the RFID reader is readily retrievable, transportable, and dispensable by the shuttle. For example, the shuttle is operable to dispense the load unit containing the RFID reader at a storage location within the ASRS when the shuttle-transported RFID reader is not required.

In another aspect, the material handling system includes a lift system for transporting load units and/or the shuttle between levels of the storage rack. An RFID reader is positioned proximate the lift system for reading RFID tags of load units transported by the lift. In yet another aspect, the material handling system includes a transportation system configured to transport load units to and from the ASRS, such as to the lift system. The transportation system may include one or more RFID readers which are each in communication with the computer for reading and recognizing an RFID tag of a load unit transported by the transportation system. The computer is operable to determine a location of a load unit relative to the RFID reader of the transportation system or another reference location within the warehouse.

Accordingly, embodiments of the present invention provide for a warehouse facility to maintain up-to-date and accurate inventory information, particularly with regard to the location or relative position of a load unit within the warehouse. A system and a method are provided for creating a database of inventory locations based on actual physical locations of stored inventory within the warehouse as well as auditing inventory databases within the system to accurately define where existing inventory is located in the warehouse. The system utilizes RFID readers positioned throughout the warehouse to read RFID tags on load units that are transported in the system as well as stored in the system. The method rectifies or audits the inventory databases by comparing the actual location of an inventory load unit (as determined with RFID systems) with the assigned or stored location of the load units. The assigned locations represent the location in which the computer of the warehouse management system believes a particular load unit to be stored in the warehouse. Auditing the inventory may be necessary if mechanical, hardware, software, or data faults occur. The use of RFID technology within the storage system of the warehouse also enables automation of the auditing process. For example, an autonomous mobile robot may enter the storage system and correct the positioning of a dislodged load unit, thereby relieving a human operator of the otherwise slow and onerous task.

These and other objects, advantages, purposes and features of this invention will become apparent upon review of the following specification in conjunction with the drawings.

### BRIEF DESCRIPTION OF THE DRAWINGS

FIG. 1 is a diagram of a method for auditing inventory in an automated warehouse, in accordance with the present invention;

FIG. 2 is a diagram of an optional method for auditing inventory in an automated warehouse continuing from the method diagram of FIG. 1;

FIG. 3A-3B are a diagram of an optional method for auditing inventory in an automated warehouse continuing from the method diagram of FIG. 2;

FIG. 4 is a perspective view of RFID enabled, automated material handling system, in accordance with the present invention;

FIG. 5 is top plan view of a RFID enabled shuttle for an RFID enabled, automated handling system, in accordance with the present invention;

FIG. 6 is a diagrammatic plan view of portion of a level of a storage rack of an automated material handling system; and

FIG. 7 is a plan view of a transportation system for an automated warehouse.

### DESCRIPTION OF THE PREFERRED EMBODIMENTS

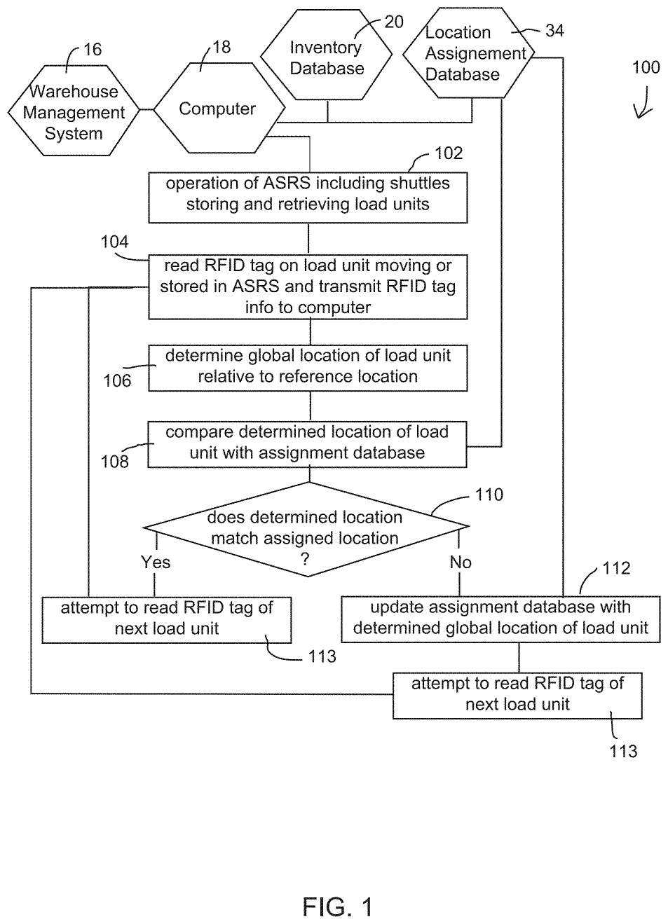

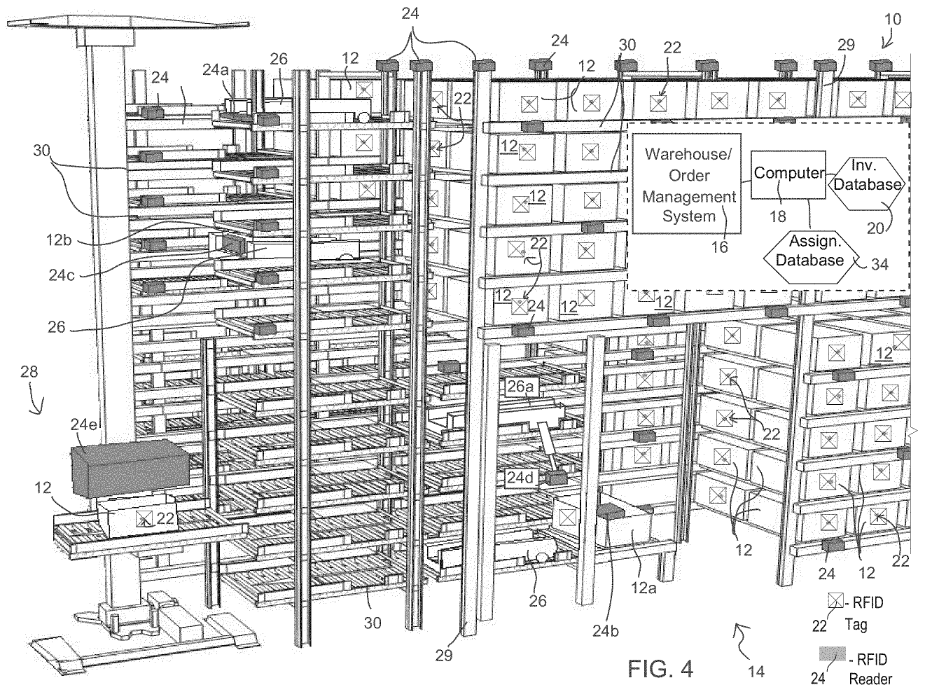

Referring now to the drawings and the illustrative embodiments depicted therein, an RFID enabled, automated material handling system 10 (FIGS. 4-6) and a method 100 (FIGS. 1-3) are provided for locating and monitoring movement and storage locations of load units 12 (e.g. totes, receptacles, containers, shipping cartons, and the like) within a warehouse. The system 10 and method 100 are particularly well-suited for auditing, verifying, and validating inventory on hand within a warehouse having an automated storage and retrieval system (ASRS) 14, such as maintaining an up-to-date database of inventory items and the load units 12 that contain them as they enter, move about, and exit the ASRS 14. For simplicity, the terms locating, monitoring, tracking, auditing, verifying, and validating processes are hereinafter collectively referred to as “auditing processes”, where appropriate. The system 10 includes a warehouse management system (WMS) 16 having a computer 18 and the method 100 enables the WMS 16 to keep track of load units 12 at substantially all times, as opposed to only when a load unit 12 enters or exits a particular function or component of the warehouse (e.g. at an induct of an ASRS). The method 100 determines whether the inventory data and the physical locations of the inventory within a warehouse match or agree with the inventory information stored in an inventory database 20 of the WMS 16. The load units 12 within the warehouse are fitted with RFID tags 22 (FIG. 4). The system 10 utilizes one or more RFID readers 24 positioned throughout the warehouse to read and recognize the RFID tags 22 on the load units 12 as the units move through the system 10 and/or while the units are stored in the system (FIG. 4). The system 10 and method 100 utilize the RFID reader 24 and RFID tag 22 on a load unit 12 to identify the load unit and determine its global location within the warehouse. Features of the system may include one or more of RFID readers 24a coupled to a shuttle 26 of the ASRS, an RFID reader 24b disposed in a load unit 12a which is readily retrievable, transportable, and dispensable by the shuttle 26, multiple RFID readers 24 spaced throughout the warehouse (e.g. an RFID reader 24e at a lift system 28, or RFID readers 24 at various positions in the ASRS 14, along conveyors, sorters, inducts, etc.), as well as optional RFID tags fixed to individual inventory items (FIG. 4).

RFID tags 22 affixed to each load unit 12 provide for information storage and a short-range transmitter for the load unit, and in this manner, unique RFID identifiers may be assigned to each load unit 12 within the system 10. The RFID tag 22 enables an RFID reader 24 and the WMS 16 to match information from the RFID tag 22 of the load unit 12 against the inventory database 20 and/or location assignment database 34 to determine the inventory stored in a particular load unit 12 and that load unit's location within the system 10. The system 10 and method 100 may reduce or eliminate undesirable downtime that is commonly required to audit the inventory within an ASRS. For example, if a load unit is misplaced at an improper storage location (e.g. dropped by an automated shuttle), an operator may be required to physically enter the ASRS to identify the load unit and either reposition in the proper location or update the WMS with the actual location information. Other examples of undesired downtime include mechanical faults and vibrations which may result in load units being out of position as compared to the location that is assigned by the computer and software (e.g. where the computer expects the load unit to be), personnel/operators in the rack mistakenly moving a load unit to a position that is different than determined/assigned by the computer and software, or data of stored inventory within the computer may be lost or corrupted, etc. The system utilizing RFID readers and RFID tags may reduce or eliminate the need for a human operator to enter the storage rack to identify a tote or other load unit that is out of position, which, if required, typically causes a significant amount of downtime. The RFID enabled system and methods may minimize or eliminate the need for barcode scanners throughout the system, which are typically only positioned at entry and exit points of the ASRS to determine when a load unit has entered or exited the ASRS. While it is preferable that all load units include an RFID tag, it will be appreciated that the system and methods remain advantageous in instances where only some of the load units in a warehouse have RFID tags.

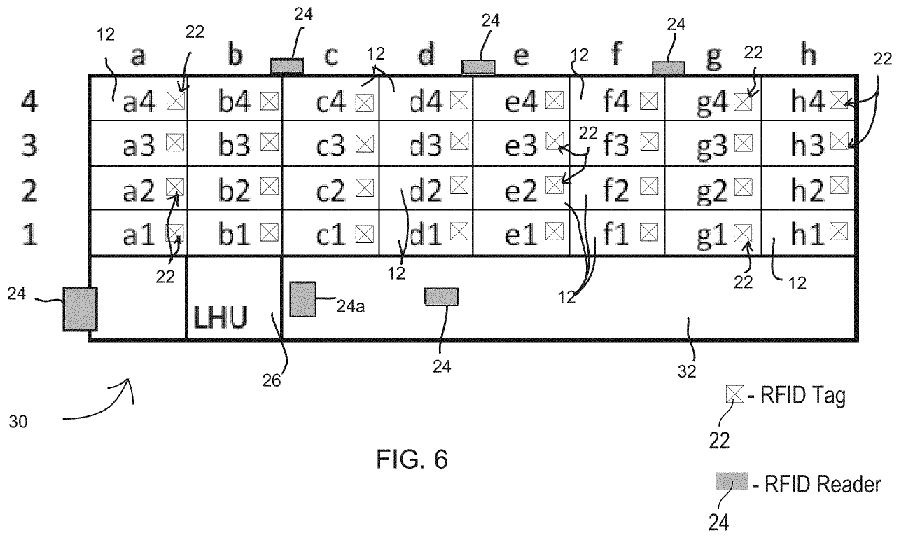

Referring now to the illustrative embodiments of FIGS. 1-6, the method 100 and the RFID enabled material handling system 10 are provided for locating, monitoring, and tracking RFID tagged load units 12 within a warehouse to maintain an accurate, real-time inventory database 20 within a warehouse management system (WMS) 16 of the warehouse. The system 10 includes the automated storage and retrieval system (ASRS) 14, which may be configured similar to various commonly known and available storage and retrieval systems. As depicted in FIGS. 4 and 6, the ASRS 14 is defined in part by a storage rack 29 having multiple levels 30 defining storage locations for load units 12. Shuttles 26 operate within aisles 32 (FIGS. 4 and 6) of each level 30 and a lift system 28 is provided for transporting load units 12 and/or shuttles 26 between the levels 30 and/or to upstream/downstream processes or functions (e.g. conveyors, sorters, pick stations, etc.). The method 100 includes controlling 102, with the computer 18 of the WMS 16, operation of the ASRS 14 including directing the shuttles 26 to store and retrieve load units 12 throughout the ASRS. The system 10 includes multiple RFID readers 24, 24a, 24b, 24c, 24d and/or 24e positioned throughout the ASRS 14 and coupled to various components of the ASRS (FIG. 4). It will be appreciated that the quantity and required positioning of RFID readers may vary based on various factors, such as the size of the warehouse, the budget for constructing the warehouse, the requirements for frequency of RFID tracking, etc. For example, a single RFID reader 24 may be all that is necessary to read and recognize all of the load units 12 within a warehouse, such an example will be discussed in further detail below. The computer 18 may be programed with computer code and comprise one or more processors as well as hardware and software, including for performing the operations discussed herein.

The method 100 includes attempting 104 to read and recognize an RFID tag 22 of each load unit 12 that is present in the ASRS 14 with one or more of the RFID readers 24 positioned within the ASRS. The RFID reader 24 is in communication with the WMS 16 and transmits any information gathered from an RFID tag to the WMS 16. For every load unit RFID tag that is recognized, the computer 18, in coordination with a warehouse positioning system, utilizes information from the RFID reader 24 to determine 106 a global location or position of the respective load unit 12 relative to a reference location within the ASRS 14 or some other global reference point within the warehouse. The computer 18 compares 108 the actual location of the load unit 12 determined at 106 with an assignment database 34 of assigned load unit storage locations which define the assigned, desired, or otherwise predetermined storage locations for at least some of the plurality of load units 12 within the ASRS 14. It is then determined 110, based on the comparison 108 of actual location vs. assigned location, whether a particular load unit's actual, determined location matches its assigned storage location. If the determined location of a load unit 12 does not match its assigned storage location, the computer 18 updates 112 that load unit's assigned storage location in the assignment database 34 to correspond with the load unit's actual, determined location.

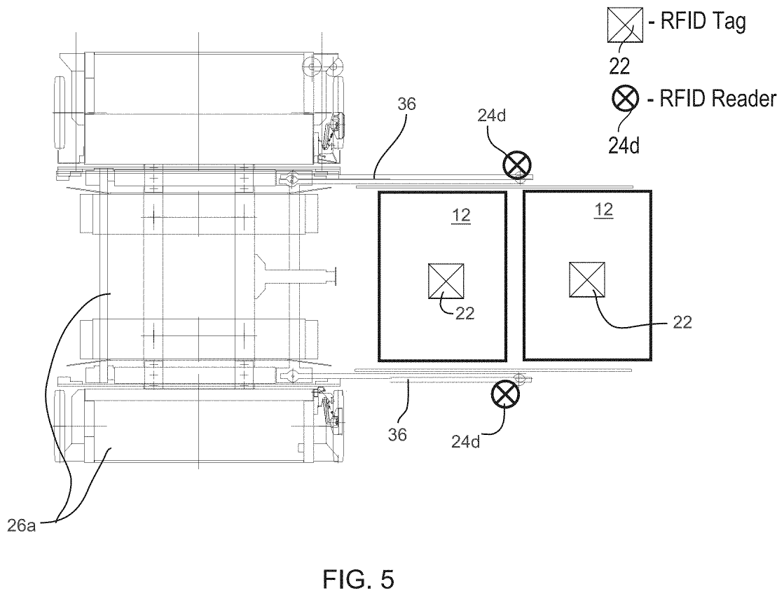

As mentioned briefly above, embodiments are contemplated in which a single RFID reader 24 may be adequate to meet the auditing processes requirements of a warehouse. The following describes such an example in which an RFID reader 24a, 24b, 24c, or 24d is transported on the shuttle 26 and may be sufficient without the need for any additional RFID readers (FIGS. 4-6). The RFID reader may be fixed to the shuttle 26 such as illustrated by RFID reader 24a of FIGS. 4 and 5 and therefore be permanently transportable by the shuttle 26. Alternatively, as respectively illustrated by RFID readers 24b and 24c of FIG. 4, the RFID reader may be removably contained within a load unit 12a or fixed to a portion of a load unit 12b and therefore be removably and selectively transportable on the shuttle 26. Removably and selectively transportable RFID readers 24b and 24c and load units 12b and 12c will be discussed in further detail below.

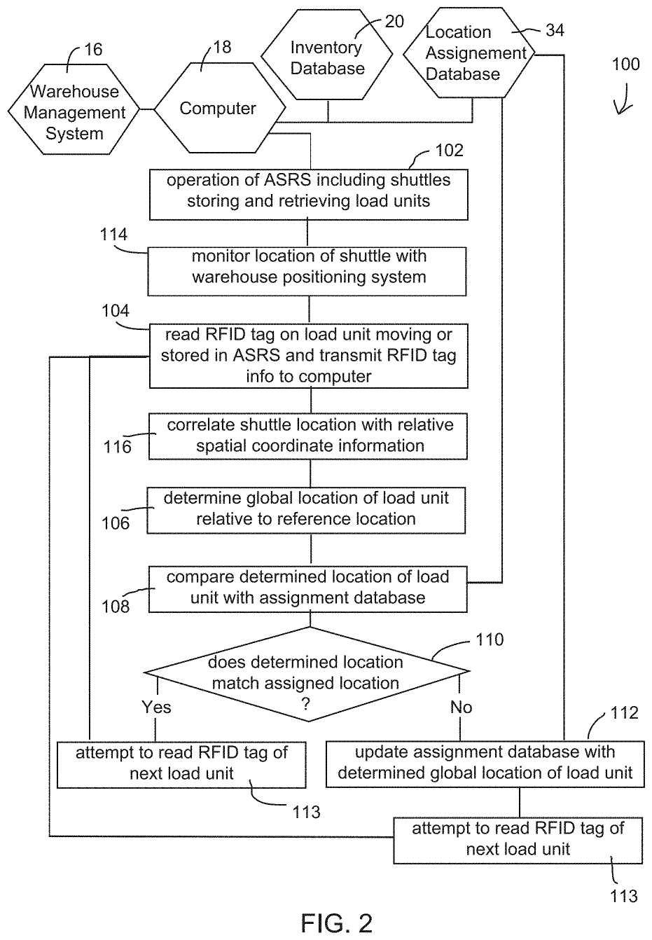

By providing the RFID reader 24a, 24b, 24c or 24d on the shuttle 26, the system 10 and method 100 may reduce complexity of the WMS 16 and associated programmable logic controllers (PLCs), reduce infrastructure requirements and costs, and optionally enable the shuttle 26 to selectively perform auditing functions when required and/or perform normal shuttle operations (i.e. transporting load units). The method 100 may further include controlling 114 the shuttle 26, with the WMS 16, to traverse along the aisle 32 while monitoring the location of the shuttle 26 with the warehouse positioning system which is adapted to determine a global location of the shuttle 26 (e.g. instantaneous location), and the RFID reader 24a, 24b, 24c or 24d in particular, relative to the ASRS 14 or some other global reference point within the warehouse (FIG. 2). As the shuttle 26 traverses the aisle 32, the RFID reader 24a, 24b, 24c or 24d on the shuttle 26 attempts 104 to read and recognize an RFID tag 22 of each load unit 12 that is stored at a storage location adjacent to the particular aisle 32 the shuttle 26 is operating in. It will be appreciated that the RFID reader 24a, 24b, 24c or 24d on the shuttle 26 may also be capable of reading RFID tags 22 of load units 12 on superjacent and/or subjacent levels 30, thereby increasing the efficiency of the auditing processes. Preferably, the WMS 16 is capable of determining relative distances between the RFID reader 24a, 24b, 24c or 24d and the RFID tag 22 of a particular load unit 12. As such, in order to determine at 106 a location of a particular load unit 12 includes correlating 116 the shuttle 26 location as determined by the warehouse positioning system (preferably recorded at the same time that the shuttle supported RFID reader 24a, 24b, 24c or 24d reads the particular load unit's RFID tag 22) with the relative shuttle/load unit distances for the particular load unit RFID tag 22 as determined by the WMS 16 to determine or compute 106 the global location of each respective load unit 12 relative to the ASRS 14 or some other global reference point within the warehouse (FIG. 2).

As mentioned above, the RFID reader 24b or 24c may be selectively supported on and transportable on the shuttle 26 (FIG. 4). In such embodiments, the shuttle 26 is operable to retrieve the RFID reader 24b or 24c (by retrieving the respective load unit 12b or 12c) when required for auditing processes. As such, the RFID reader may be stored apart from the shuttle 26 when auditing processes are not required. For example, once the auditing processes are completed, the shuttle 26 may dispense or store the load unit 12a or 12b with RFID reader 24b or 24c at an open storage location within the ASRS 14 and the shuttle 26 may then return to typical storage and retrieval operations.

The system 10 may utilize commonly known and readily available RFID tag and reader technology, in which an optional embodiment is described below. However, in a preferred embodiment, the system 10 utilizes advanced RFID tag and reader technology in which the location of an RFID tag may be accurately determined within a three-dimensional (3D) space (i.e. spatial coordinate system). The advanced RFID reader may also be capable of determining orientation information of a particular RFID tag. The advanced RFID reader and tag technology may be capable of reading RFID tags in many different directions as well as RFID tags that are obscured by other materials, such as tags obscured by other load units. For example, an ASRS may include load units stored two or three units deep in rows and the advanced RFID reader may be capable of reading and determining the location and/or orientation of an RFID tag on any of the load units within a row. As such, the advanced RFID reader is capable of reading the RFID tag 22 of the furthest load unit 12 even though the furthest load unit 12 is positioned at the back of the row, potentially behind two or more intermediate load units that are closer to the main aisle 32.

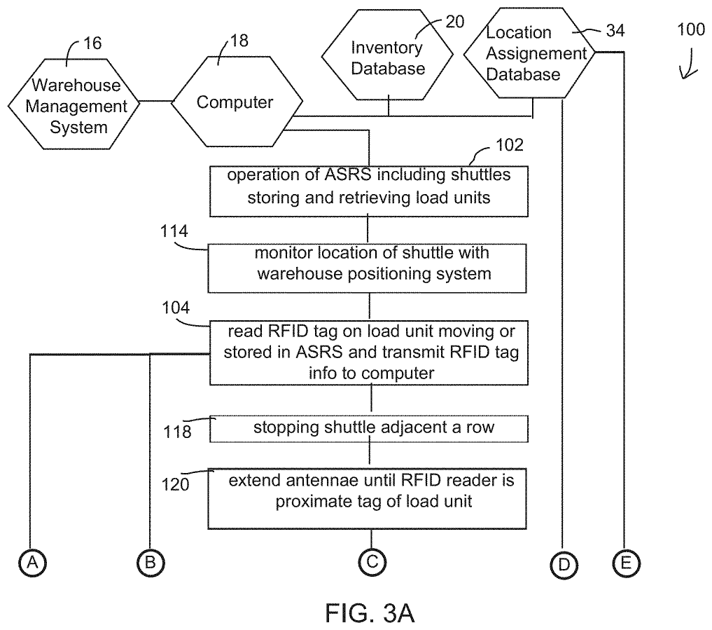

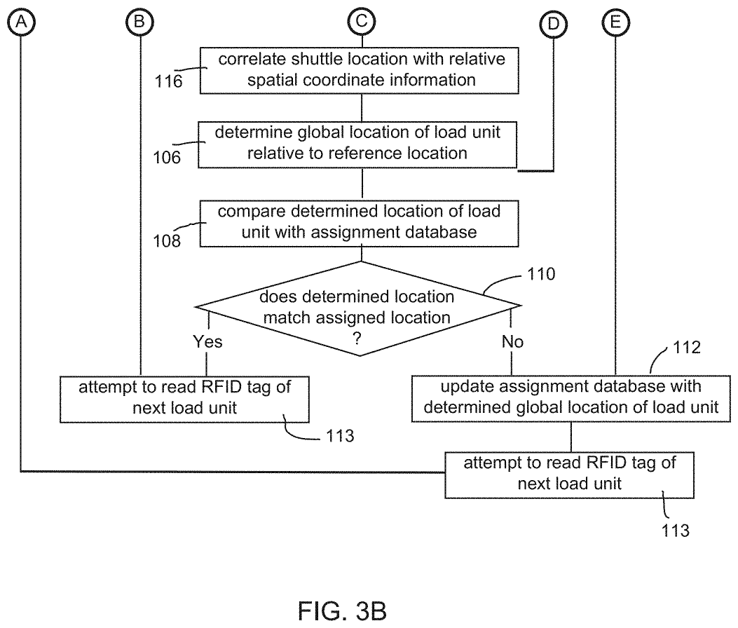

As briefly mentioned above, the system 10 and method 100 may also utilize commonly known and readily available RFID readers and tags. It will be appreciated that one or more of various types and forms of RFID tags may be utilized with the system and method. Some examples of RFID tag types include ultra-high-frequency (UHF) RFID tags, high-frequency (HF) RFID tags, near field communication (NFC) RFID tags, and low-frequency (LF) RFID tags. In order to utilize such readily available RFID technology, it may be necessary that the system include optional features to enable adequate coverage based on the signal range capabilities of readily available RFID readers. Because readily available RFID readers and tags may have a limited operating or signal range in which a reader can accurately and effectively read an RFID tag, it may be necessary that RFID tags on load units be able to pass within a close proximity to an RFID reader. Accordingly, the system 10 may include a multitude of readily available RFID readers throughout the facility to provide a blanket of RFID reader coverage, for example. As such, in most instances, load units 12 stored at storage locations are within sufficient range of an RFID reader and/or as a load unit passes through the system 10, the RFID tag of the load unit will pass within sufficient range of an RFID reader 24 (FIGS. 4 and 6). Optionally, as illustrated with shuttle 26a of FIGS. 4 and 5, an extendable arm or antennae 36 is coupled with the shuttle 26a and an RFID reader 24d is attached to an extending, distal end of the antennae 36. The arm 36 may be dimensioned such that it is capable of reaching beneath, above, or around an intermediate load unit 12 and then deeper into a row of a storage rack 29 to scan or read an RFID tag 22 of a load unit 12 that is positioned behind the intermediate load unit. As such, attempting at 104 to read and recognize an RFID tag 22 of each load unit may include the WMS 16 stopping 118 the shuttle 26a along the aisle 32, adjacent a row, and extending 120 the extendable arm 36 toward that row such that the RFID reader 24d enters into close proximity to a load unit 12 at a storage location within that row. The RFID reader 24d then attempts 104 to read and recognize the RFID tag 22 on the load unit 12 (FIGS. 3A-3B). Once all of the RFID tags 22 of load units 12 within the row are read and recognized, the arm 36 retracts and the WMS 16 directs the shuttle 26a to move to the next row and continue the auditing processes.

In the preferred embodiment, the contemplated improved or advanced RFID readers and tags require a proximity of a tag relative to the reader that is significantly reduced as compared to previously known or available RFID technology. Additionally, the improved RFID reader is contemplated to be capable of reading or sensing RFID tags through materials that block or impede a line of sight between the reader and the tag. For example, the RFID reader may sense an RFID tag on a subject load unit situated on a storage rack behind two additional load units that are positioned between the subject load unit and the RFID reader. Further, the improved RFID reader is contemplated to be capable of interpreting or determining spatial coordinates of an RFID tag relative to the RFID reader. The reader may also be capable of identifying a relative orientation of the RFID tag relative to the reader. For example, the reader may determine that a particular RFID tag is 0.75 meters away from the reader in the x-coordinate, 1.2 meters from the reader in the y-coordinate, and 0.6 meters from the reader in the z-coordinate. This relative spatial coordinate information is transmitted to the WMS 16 which utilizes the spatial coordinate information to determine, calculate, or otherwise correlate with other known location information, what the global location of a load unit 12. The WMS 16 then compares the global location of the load unit 12 with the inventory database 20 and/or location assignment database 34 to verify, validate, and ultimately audit the inventory information within the WMS 16.

While RFID tags and readers are a preferred information storage unit and identifier for the system 10 and method 100 due to their inherent portability and inconspicuousness, it will be appreciated that other acceptable information storage units and identifiers may be utilized for the system and method within the facility, such as real-time location systems (RTLS) (e.g. ultra-wide band RTLS, Wi-Fi RTLS, or infrared RTLS), for example.

Inventory auditing processes (e.g. validation) may be performed routinely or on demand. Auditing processes may be automatically requested following a machine fault (computer hardware or software malfunction, mechanical failure, etc.), such as to quickly and efficiently correct any errors in the system 10 or to ensure that no critical data loss occurs as a result of the machine fault, for example. Alternatively, a human operator or maintenance technician may manually request an audit or auditing process if they recognize an error or malfunction, or if they believe that there may be an error or malfunction in the system 10. Further, the system 10 and method 100 may be adapted for populating an initial inventory database 20 and/or location assignment database 34. For example, a shuttle 26 may start at the end of one aisle 32 and populate an inventory database 20 as it moves down the aisle 32, attempting 104 to read and recognize the RFID tag 22 of each load unit 12 stored adjacent to that aisle 32. Performing inventory auditing processes routinely may ensure a high degree of accuracy within the system 10, both in terms of real-time inventory management and load handling unit control.

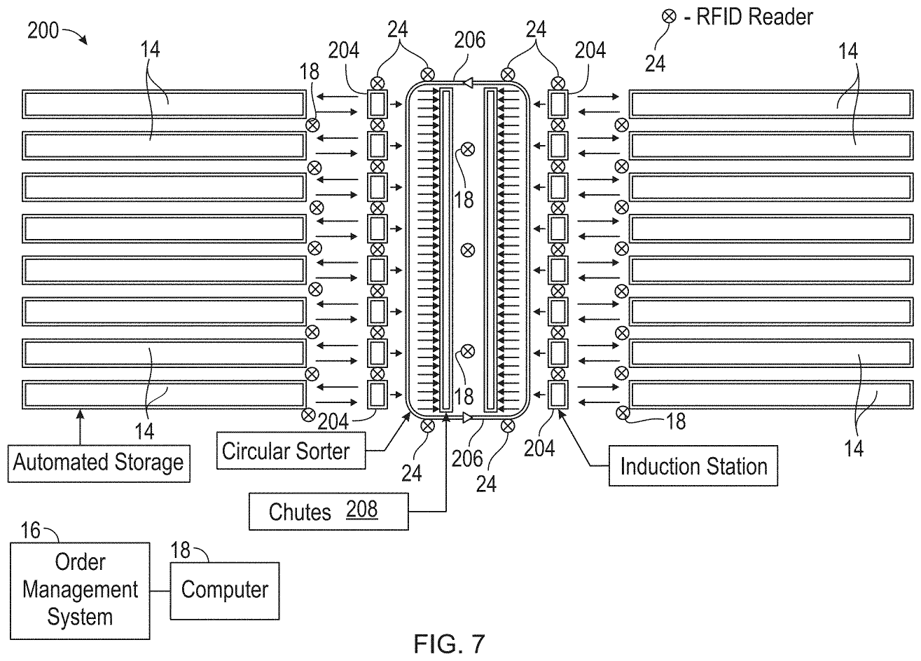

Referring to the illustrative embodiment of FIG. 7, an exemplary RFID enabled material handling and transportation system 200 is provided for an order fulfilment or warehouse facility. For example, the handling and transportation system 200 may include similar structure and functionality to that disclosed in commonly owned and assigned U.S. patent application Ser. No. 17/976,264, filed Oct. 28, 2022, the disclosure of which is hereby incorporated by reference herein in its entirety. Further, it will be appreciated that other order fulfilment facilities, warehouse facilities, and material handling systems having different configurations of components, systems, dimensions, etc. may benefit from the use of an RFID enabled material handling and transportation system similar to that described herein. The system 200 of FIG. 7 may be provided with or incorporated into system 10 as described above and illustrated in FIGS. 4-6.

The material handling system 200 includes a transportation system 202 configured to transport load units 12 to and from the ASRS 14 as well as transporting load units 12 and/or individual inventory items to various components or functions of the warehouse (FIG. 4). The transportation system 200 may include one or more RFID readers 24 in communication with the computer 18 and configured to read and recognize RFID tags 22 of load units 12 and individual inventory items transported by the transportation system 200. The computer 18 is operable to determine a location of a load unit 12 relative to an RFID reader 24 of the transportation system 200 or some other global reference point within the warehouse (FIG. 7). The exemplary system 200 includes induction stations or inducts 204 and a circular sortation system or sorter 206. Utilizing the tracked spatial coordinate information of an item's RFID tag, the computer 18 may direct the sorter 206 to divert load units 12 or individual items to appropriate chutes 208 to be directed to downstream processes. For example, the handling and transportation system 200 may include similar structure and functionality to that disclosed in commonly owned and assigned U.S. provisional patent application Ser. No. 63/312,945, filed Feb. 23, 2022, entitled OMNICHANNEL SORTATION SYSTEM, the disclosure of which is hereby incorporated by reference herein in its entirety. Accordingly, the RFID enabled handling and transportation system 200 utilizes RFID readers 24 and RFID tags 22 on load units 12 and/or individual inventory items to direct the items to appropriate locations and processes within the facility, such as the ASRS 14, and also verifies and validates that the load units 12 and inventory items are delivered to their appropriate location.

Thus, the embodiments of the system and method of the present invention provide for auditing the inventory within an automated warehouse utilizing RFID technology. The system and method are also capable of real-time tracking and monitoring of inventory and load units as they travel through and are stored in the warehouse. The system may utilize multiple RFID readers positioned throughout the warehouse to enable adequate RFID signal coverage for real-time, whole warehouse inventory tracking. Alternatively, or in addition to, the system may only require a single RFID reader coupled with an automated shuttle that is capable of traversing a majority of the warehouse storage system to audit the inventory stored in load units throughout the storage system. The system and method are operable when utilizing readily available RFID technologies. Additionally, the system and method of the present invention contemplate advanced or improved RFID technologies with greater detection range, larger information storage capabilities, and the ability to determine a precise spatial location of an RFID tag relative to an RFID reader.

Changes and modifications in the specifically described embodiments can be carried out without departing from the principles of the present invention which is intended to be limited only by the scope of the appended claims, as interpreted according to the principles of patent law including the doctrine of equivalents.

1. A method for determining locations of load units in a warehouse having a warehouse management system (WMS) controlling an automated storage system in which inventory items are stored in a plurality of load units that are stored at a plurality of storage locations within the storage system, said method comprising:
attempting to read and recognize a radio frequency identification (RFID) tag that is affixed to at least some of the load units present in the storage system with an RFID reader positioned at the storage system, the RFID reader is in communication with the WMS; and
for every load unit RFID tag that is recognized, determining a position of the respective load unit relative to a reference location within the storage system with a warehouse positioning system which is in communication with the WMS and configured to receive information from the RFID reader.

2. The method of claim 1, further comprising validating inventory in a warehouse, said validating comprising:
comparing the determined position of each load unit with a database of assigned load unit storage locations that includes an assigned storage location for at least some of the plurality of load units within the storage system;
determining whether a particular load unit's determined location matches its assigned storage location; and
if the determined location of a load unit does not match its assigned storage location, updating that load unit's assigned storage location in the database to the load unit's determined location.

3. The method of claim 1, wherein the storage system includes a storage rack defining at least some of the plurality of storage locations and a shuttle operable within an aisle of the storage rack, wherein the RFID reader is disposed on the shuttle, said method further comprising:
controlling the shuttle, with the WMS, to traverse along the aisle;
monitoring the location of the shuttle with the warehouse positioning system which is adapted to determine a location of the shuttle relative to the storage rack; and
wherein as the shuttle traverses the aisle, the RFID reader on the shuttle attempting to read and recognize RFID tags of load units stored at a storage location adjacent to the aisle;
wherein said determining a position of the respective load unit comprises correlating the position of the shuttle with each load unit RFID tag that is recognized to determine a location of each respective load unit relative to the storage rack.

4. The method of claim 3, wherein the RFID reader is fixed to a portion of the shuttle.

5. The method of claim 4, wherein the storage rack comprises rows perpendicular to the aisle and each row comprising at least one of said plurality of storage locations and the shuttle comprises an extendable arm selectively operable to extend into a row to attempt to read an RFID tag of a load unit present in that row, wherein the RFID reader is coupled to a distal end of the extendable arm, wherein said attempting to read and recognize an RFID tag of each load unit comprises the WMS stopping the shuttle along the aisle adjacent a row, extending the extendable arm toward that row such that the RFID reader is in close proximity to a load unit at a storage location within that row, and attempting to read and recognize the RFID tag on the load unit.

6. The method of claim 5, wherein each row comprises a plurality of storage locations for storing load units and the extendable arm is operable to extend beyond a first load unit in a row which is the load unit closest to the aisle in order to attempt to read an RFID tag of another load unit at a storage location behind the first load unit.

7. The method of claim 3, wherein the RFID reader is selectively supported on and transportable on the shuttle, wherein the shuttle is operable to retrieve the RFID reader when required for auditing processes and the RFID reader is storable apart from the shuttle when auditing processes are not required.

8. The method of claim 1, wherein the storage system includes a storage rack defining at least some of the plurality of storage locations and the storage system comprises a plurality of the RFID readers positioned in spaced arrangement throughout the storage rack and each having a known reference location relative to the storage rack, each of the plurality of RFID readers is in communication with the WMS and operable to read RFID tags of load units which are stored at storage locations which are within sufficiently close proximity to the respective RFID reader, wherein determining a position of the respective load unit comprises the warehouse positioning system receiving information from one of the plurality of RFID readers that has read and recognized the RFID tag of the respective load unit and calculating the location of the respective load unit relative to the storage rack based on the known reference location of that RFID reader.

9. The method of claim 1, wherein the storage system includes a storage rack having a plurality of levels each defining a plurality of storage locations, a shuttle operable to traverse an aisle of at least one of the levels of the storage rack to store and retrieve load units at the plurality of storage locations adjacent the aisle, and a lift system operable to transport load units between levels of the storage rack, wherein an RFID reader is positioned proximate the lift system for reading RFID tags of load units transported by the lift.

10. The method of claim 2, further comprising the WMS receiving any spatial and orientation information for each load unit RFID tag that is recognized from the RFID reader; for every load unit RFID tag that is recognized, the WMS determining a global position of the respective load unit relative to a reference location within the storage system; and storing the global position of each load unit in an inventory database of the WMS.

11. The method of claim 10, wherein the storage system includes a storage rack defining at least some of the plurality of storage locations and a shuttle operable within an aisle of the storage rack, wherein the RFID reader is disposed on the shuttle, said method further comprising:
controlling the shuttle, with the WMS, to traverse along the aisle;
monitoring the location of the shuttle with the warehouse positioning system which is adapted to determine a location of the shuttle relative to the storage rack; and
wherein as the shuttle traverses the aisle, the RFID reader on the shuttle attempting to read and recognize RFID tags of load units stored at a storage location adjacent to the aisle; and
wherein said determining a global position of the respective load unit comprises correlating the reference location of the shuttle with the spatial and orientation information of each load unit RFID tag that is recognized to determine a location of each respective load unit relative to the storage rack.

12. A method for determining locations of load units in a warehouse having a warehouse management system (WMS) controlling an automated storage system in which inventory items are stored in a plurality of load units that are storable at a plurality of storage locations within the storage system, said method comprising:
storing individual load units containing one or more inventory items at respective storage locations within the storage system, wherein each load unit comprises a radio frequency identification (RFID) tag having a unique RFID identifier;
enabling an RFID reader disposed at the storage system and in communication with the WMS, wherein the RFID reader is operable to read and recognize RFID tags present in the storage system and to determine spatial coordinate and/or orientation information of recognized RFID tags;
attempting to read and recognize RFID tags of load units present in the storage system with the RFID reader;
the WMS receiving any spatial and orientation information for each load unit RFID tag that is recognized from the RFID reader;
for every load unit RFID tag that is recognized, the WMS determining a global position of the respective load unit relative to a reference location within the storage system; and
storing the global position of each load unit in an inventory database of the WMS.

13. The method of claim 12, wherein the storage system includes at least one shuttle operable within an aisle of a storage rack, wherein the RFID reader is disposed at the shuttle, said method further comprising:
controlling the shuttle, with the WMS, to traverse along the aisle;
monitoring the location of the shuttle with a warehouse positioning system which is adapted to determine a location of the shuttle relative to the storage rack, wherein the determined location of the shuttle provides a reference location within the storage system; and
wherein as the shuttle traverses the aisle, the RFID reader on the shuttle attempting to read and recognize an RFID tag of each load unit that is stored at a storage location adjacent to the aisle;
wherein said determining a global position of the respective load unit comprises correlating the reference location of the shuttle with the spatial and orientation information of each load unit RFID tag that is recognized to determine a location of each respective load unit relative to the storage rack.

14. The method of claim 13, wherein the RFID reader is fixed to a portion of the shuttle.

15. The method of claim 14, wherein the storage rack comprises rows perpendicular to the aisle and each row comprising at least one of the plurality of storage locations and the shuttle comprises an extendable arm selectively operable to extend into a row to attempt to read an RFID tag of a load unit present in that row, wherein the RFID reader is coupled to the extendable distal end of the extendable arm, wherein said attempting to read and recognize an RFID tag of each load unit comprises the WMS stopping the shuttle along the aisle adjacent a row, extending the extendable arm toward that row such that the RFID reader is in close proximity to a load unit within that row, and attempting to read and recognize the RFID tag on the load unit.

16. The method of claim 15, wherein each row comprises a plurality of storage locations for storing load units and the extendable arm is operable to extend beyond a first load unit in a row which is the closest load unit to the aisle in order to attempt to read an RFID tag of another load unit at a storage location behind the first load unit.

17. The method of claim 13, wherein the RFID reader is selectively supported on and transportable on the shuttle, wherein the shuttle is operable to retrieve the RFID reader when required for load unit locating processes within the storage system and the RFID reader is storable apart from the shuttle when load unit locating processes are not required.

18. The method of claim 12, wherein the storage system includes a storage rack defining at least some of the plurality of storage locations and the storage system comprises a plurality of the RFID readers positioned in spaced arrangement throughout the storage rack and each having a known reference location relative to the storage rack, each of the plurality of RFID readers is in communication with the WMS and operable to read RFID tags of load units which are stored at storage locations which are within sufficiently close proximity to a respective one of the RFID readers, wherein said determining a global position of the respective load unit comprises the warehouse positioning system receiving information from one of the plurality of RFID readers that has read and recognized the RFID tag of the respective load unit and calculating the location of the respective load unit relative to the storage rack based on the known reference location of that RFID reader and the spatial and orientation information of the respective load unit.

19. The method of claim 12, wherein the storage system includes a storage rack having a plurality of levels each defining a plurality of storage locations, a shuttle operable to traverse an aisle of at least one of the levels of the storage rack to store and retrieve load units at the plurality of storage locations adjacent the aisle, and a lift system operable to transport load units between levels of the storage rack, wherein an RFID reader is positioned proximate the lift system for reading RFID tags of load units transported by the lift system.

20. An RFID enabled material handling system for an automated warehouse, said material handling system comprising:
a warehouse management system (WMS) comprising a computer configured to control said material handling system;
an automated storage and retrieval system (ASRS) comprising a storage rack having a plurality of rack levels defining a plurality of storage locations each configured to support a load unit containing one or more inventory items; and
a plurality of radio frequency identification (RFID) readers positioned proximate various portions of said ASRS, each RFID reader having a known location relative to said ASRS and said RFID readers in communication with said computer and configured to read and recognize an RFID tag coupled to a load unit that is present in the ASRS and in sufficient proximity to a respective one of said RFID readers, each of said RFID reader configured to communicate information associated with a recognized RFID tag to said computer; and
said computer operable to determine a location of a load unit relative to said ASRS utilizing information of the load unit's RFID tag, as provided by the respective RFID reader that read and recognized the tag, and the known location of that respective RFID reader relative to the ASRS.

21. The material handling system of claim 20, wherein said ASRS further comprising a shuttle operable to traverse an aisle of at least one of said plurality of rack levels of said storage rack.

22. The material handling system of claim 21, further comprising an RFID reader disposed at said shuttle and configured to read and recognize RFID tags of load units that are stored at storage locations adjacent the aisle and/or supported at said shuttle, wherein said RFID reader at said shuttle is configured to communicate information associated with a recognized RFID tag to said computer.

23. The material handling system of claim 22, wherein said RFID reader is disposed at said shuttle in a manner chosen from one of (i) fixed to a portion of said shuttle, (ii) moveably coupled to said shuttle, and (iii) selectively supported on said shuttle.

24. The material handling system of claim 23, wherein said RFID reader is selectively supported on said shuttle and contained within a load unit such that said RFID reader is readily retrievable, transportable, and dispensable by said shuttle such that said shuttle is operable to dispense the load unit containing said RFID reader at a storage location within said ASRS.

25. The material handling system of claim 21, further comprising a lift system operable to transport load units and/or the shuttle between levels of the storage rack, wherein an RFID reader is positioned proximate said lift system for reading RFID tags of load units transported by the lift.

26. The material handling system of claim 20, further comprising a transportation system configured to transport load units to and from said ASRS, said transportation system comprising an RFID reader which is in communication with said computer and configured to read and recognize an RFID tag of a load unit transported by said transportation system and said computer operable to determine a location of a load unit relative to at least one chosen from (i) said RFID reader of said transportation system and (ii) a known reference location within said material handling system.
